(19) United States
(12) Patent Application Publication
(10) Pub. No.: US 2024/0014624 A1
(43) Pub. Date: Jan. 11, 2024

(54) PASSIVELY DOUBLE-PASSED CHIRPED-FIBER-BRAGG-GRATING

(71) Applicant: Coherent Scotland Limited, Glasgow (GB)

(72) Inventors: Ian MACGILLIVRAY, Glasgow (GB); Luke MAIDMENT, Glasgow (GB)

(73) Assignee: Coherent Scotland Limited, Glasgow (GB)

(21) Appl. No.: 18/345,599

(22) Filed: Jun. 30, 2023

(30) Foreign Application Priority Data
Jul. 8, 2022 (GB) 2210079.6

(51) Int. Cl. H01S 3/10; H01S 3/067

(52) U.S. Cl. CPC H01S 3/10038; H01S 3/0675

(57) ABSTRACT

A system 200 for altering laser pulse duration includes a chirped fiber Bragg grating (cFBG) 122, a Faraday rotator 230, a retroreflector 240, and a fiber-optic polarization combiner 210 coupled to the chirped fiber Bragg grating 122 via the Faraday rotator 230. The combiner 210 directs a laser pulse via the Faraday rotator 230 to a first reflection in the cFBG 122, then directs the laser pulse to the retroreflector 240, then directs the laser pulse via the Faraday rotator 230 to a second reflection in the cFBG 122, and then emits the laser pulse. A three-port fiber-optic circulator 250 may serve as an input/output interface. Another system for altering laser pulse duration includes a cFBG 122, a fiber-optic polarization combiner 210 coupled to the cFBG 122, and a four-port fiber-optic circulator 550 coupled to the combiner 210 to direct a laser pulse from through the combiner 210 to the cFBG 210 via two different paths. These systems passively achieve two passes through the same cFBG 210.

### CROSS-REFERENCE TO RELATED APPLICATIONS

This application claims the priority of United Kingdom Patent Application No. 2210079.6, filed Jul. 8, 2022, the entire contents of which is incorporated herein by reference.

### TECHNICAL FIELD OF THE INVENTION

The present invention relates to amplification of ultrashort laser pulses. The present invention relates in particular to the use of chirped fiber Bragg gratings to stretch the ultrafast laser pulses before amplification and/or compress the amplified ultrafast laser pulses.

### DISCUSSION OF BACKGROUND ART

Generation of high-power laser radiation is often accomplished using the master-oscillator power-amplifier (MOPA) architecture. The master oscillator is a laser that generates laser radiation of relatively low power. This low-power laser radiation is then amplified in a separate power amplifier. For example, the output of a fiber laser may be amplified in a fiber amplifier. The fiber amplifier is optimized to handle and generate much higher laser powers than the fiber laser itself. Some MOPAs include multiple stages of amplification. In multistage MOPAs, one or more preamplifiers amplify the output of the master oscillator before amplification by the power amplifier. The MOPA architecture may be applied to both continuous-wave and pulsed laser radiation. Direct amplification of ultrashort pulses is, however, often not feasible. Ultrashort laser pulses have durations of a few tens of picoseconds at most, for example between ten and a few hundred femtoseconds. The peak powers are correspondingly high, especially if amplified. Even if the power amplifier is designed to handle the high peak powers, nonlinear effects are likely to cause an unacceptable degree of pulse distortion due to, e.g., self-phase modulation. These issues associated with amplification of ultrashort laser pulses are prevented by lengthening the duration of the laser pulses prior to amplification such that amplification is applied to laser pulses with reduced peak powers. The initially ultrashort pulse duration may be stretched to as much as nanoseconds. After amplification, the laser pulses may be recompressed into the ultrashort regime.

Chirped pulse amplification utilizes the spectral bandwidth of ultrashort laser pulses to lengthen and shorten their duration. The stretcher of a chirped-pulse-amplification system chirps each laser pulse by imposing an optical path length that either increases or decreases with the wavelength of the laser radiation. This chromatic dispersion stretches the pulse. After amplification, the initial ultrashort pulse duration can be at least partly or approximately restored in a compressor that imposes the opposite chromatic dispersion from the stretcher. Either one of stretching and compression may be performed by, e.g., a pair of diffraction gratings, or a chirped Bragg grating. A chirped Bragg grating is generally simpler to align than a diffraction grating pair and can produce more stretching/compression in a more compact package.

In a chirped Bragg grating, the Bragg period either (a) increases with depth into the material, in which case shorter-wavelength light is reflected before longer-wavelength light, or (b) decreases with depth such that longer-wavelength light is reflected before shorter-wavelength light. A chirped Bragg grating may be implemented as a volume grating in a bulk optic or as a chirped fiber Bragg grating (cFBG). A cFBG is a fiber with a chirped Bragg grating encoded in its core. A cFBG is often more practical than a volume Bragg grating, especially when the ultrafast laser pulses are generated in a fiber laser.

In a typical cFBG-based stretcher or compressor, a laser pulse to be stretched or compressed is directed into a first port of a three-port fiber-optic circulator. The fiber-optic circulator then directs the laser pulse to its second port to be launched into a cFBG connected thereto. Reflection of the laser pulse in the cFBG returns the laser pulse to the second port, whereafter the fiber-optic circulator emits the now stretched or compressed laser pulse from its third port.

The amount of amplification that can be applied to a stretched laser pulse is constrained by the peak power of the incident, stretched laser pulse. If the peak power becomes too high in the amplifier, nonlinear effects will distort the laser pulse and thereby adversely affect the ability to subsequently recompress the laser. Therefore, the output pulse energy of a chirped-pulse-amplification system may ultimately be limited by how much the pulse can be stretched prior to amplification. In theory, arbitrary temporal stretching can be achieved using an arbitrarily long cFBG. However, cFBGs are not readily available beyond a certain length, e.g., about 20 centimeters. This is in part because the challenges associated with encoding an accurate, and thus non-distorting, chirped grating increase with the length of the cFBG, thereby rendering the manufacture of extra-long cFBGs cost-prohibitive or impossible.

This length-limitation may be circumvented by subjecting the laser pulse to two or more passes through cFBGs. For example, as disclosed by Fermann et al. in European Patent EP2403076, two separate cFBGs may be connected to the second and third ports of a four-port fiber-optic circulator. In this arrangement, the laser pulse is first reflected in the cFBG connected to the second port and then reflected in the cFBG connected to the third port. In U.S. Pat. No. 7,444,049, Kim et al. take a different approach to the problem and achieve multiple passes in a single cFBG. The single cFBG is integrated in a multi-pass loop, and the number of passes through the multi-pass loop is controlled by an active switch. The multi-pass loop includes a circulator, and the cFBG is connected to the circulator such that the laser pulse is reflected once in the cFBG for each pass through the multi-pass loop. An active switch directs a laser pulse into the multi-pass loop and extracts the laser pulse from the multi-pass loop after completing the number of passes necessary to achieve the required temporal stretching. The active switch may be an optical switch such as an acousto-optic modulator, an electro-optic modulator, a 2×2 optical switch, or a mechanical switch such as a movable micro mirror. The multi-pass loop may include a delay line that extends the time between subsequent returns of the same laser pulse to the active switch.

### SUMMARY OF THE INVENTION

Disclosed herein are systems for altering the duration of a laser pulse by passively double-passing the laser pulse through a cFBG. These systems may be applied to stretch or compress the laser pulse, and are suitable for implementation in a laser apparatus with chirped pulse amplification, for example in a MOPA. The systems utilize passive fiber-optic components to launch a laser pulse into the same cFBG twice. When configured as a stretcher, two passes in the cFBG result in longer pulse durations than a single pass. In a chirped pulse amplification system, the longer pulse duration allows for higher-energy amplification while keeping temporal/spectral pulse distortion at an acceptable level. This is particularly advantageous in ultrashort-pulsed laser applications that require high-quality temporal characteristics and/or recompression to the time-bandwidth limit.

As compared to systems using active switching to direct a laser pulse into the same cFBG more than once, the presently disclosed passive approach offers operational simplicity, compactness, reliability, and reduced cost. Conveniently, the present double-passing schemes may be implemented as fully fiber-coupled systems using standard fiber-optic components. cFBGs are relatively expensive as compared to standard fiber-optic components such as circulators, combiners, mirrors, and Faraday rotators. Therefore, the present double-passing scheme may provide cost savings over systems that include two separate cFBGs.

The present double-passing schemes are readily extendable to not only alter the laser pulse duration but also amplify the laser pulse. When the cFBG is configured to stretch the pulse, an integrated amplification-plus-stretching system is realized by incorporating a gain fiber in one of the fiber-couplings of the double-passing architecture. Such an integrated stretching-plus-amplification system may be implemented in a multistage MOPA. In such multistage MOPAs, the integrated stretching-plus-amplification system may serve as a preamplifier that further performs the stretching of the power amplifier.

In one aspect, a system for altering duration of a laser pulse includes a cFBG for stretching or compressing the laser pulse, a Faraday rotator configured to rotate polarization of laser radiation by 45 degrees per pass therethrough, a retroreflector, and a fiber-optic polarization combiner. The fiber-optic polarization combiner has first, second, and third combiner ports, and is configured to optically couple (a) laser radiation of a first polarization between the first and third combiner ports and (b) laser radiation of a second polarization between the second and third combiner ports. The first and second polarizations are mutually orthogonal. The third combiner port is fiber-coupled to the cFBG via the Faraday rotator, and the second combiner port is fiber-coupled to the retroreflector, whereby, when the laser pulse is coupled into the first combiner port with the first polarization, the first fiber polarization combiner (1) directs the laser pulse via the Faraday rotator to a first reflection in the cFBG, then (2) directs the laser pulse to the retroreflector, then (3) directs the laser pulse via the Faraday rotator to a second reflection in the cFBG, and then (4) emits the laser pulse from the first combiner port.

In another aspect, a system for altering duration of a laser pulse includes a cFBG for stretching or compressing the laser pulse, a fiber-optic polarization combiner, and a fiber-optic circulator. The fiber-optic polarization combiner has first, second, and third combiner ports. The fiber-optic polarization combiner is configured to optically couple (a) laser radiation of a first polarization between the first and third combiner ports and (b) laser radiation of a second polarization between the second and third combiner ports. The first and second polarizations are mutually orthogonal. The third combiner port is fiber-coupled to the cFBG. The fiber-optic circulator has first, second, third, and fourth circulator ports. The fiber-optic circulator is configured to (a) emit from the second circulator port laser radiation coupled into the first circulator port, (b) emit from the third circulator port laser radiation coupled into the second circulator port, and (c) emit from the fourth circulator port laser radiation coupled into the third circulator port. The second circulator port is fiber-coupled to the first combiner port to direct a laser pulse, coupled into the first combiner port, to a first reflection in the cFBG, and the third circulator port is fiber-coupled to the second combiner port to subsequently direct the laser pulse to a second reflection in the cFBG.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates a pulsed laser apparatus with chirped pulse amplification utilizing a passively double-passed cFBG to stretch the laser pulse before amplification, according to an embodiment.

FIG. 2 illustrates a system for stretching or compressing a laser pulse by passively double-passing the laser pulse through a cFBG, according to an embodiment. A three-port fiber-optic circulator serves as an input/output interface of the system.

FIG. 3 illustrates an embodiment of the FIG. 2 system wherein a polarization combiner and a Faraday rotator cooperate to form the three-port fiber-optic circulator.

FIG. 4 illustrates an embodiment of the FIG. 2 system with the three-port fiber-optic circulator based on a 2×2 fiber-optic coupler.

FIG. 5 illustrates a system, for stretching or compressing a laser pulse, which utilizes a four-port fiber-optic circulator to passively double-pass the laser pulse through a cFBG, according to an embodiment.

FIG. 6 illustrates another system that utilizes a 2×2 fiber-optic coupler to double-pass a laser pulse through a cFBG in order to stretch or compress the laser pulse, according to an embodiment.

FIGS. 7, 8, and 9 are data plots that demonstrate the performance of an example of the system of FIG. 2 as well an example of the system of FIG. 5, and compares the performance of these two systems to the performance of a system that only single-passes the cFBG. Pulse duration data is shown with open squares, and Strehl ratio data is shown with closed squares.

FIG. 10 illustrates a system for stretching and amplifying a laser pulse by passively double-passing the laser pulse through both a cFBG and a gain fiber, according to an embodiment. The system of FIG. 10 utilizes a four-port fiber-optic circulator to achieve the two passes in the cFBG and gain fiber.

FIG. 11 is a data plot that demonstrates the performance of an example of the system of FIG. 10.

FIG. 12 illustrates another system that utilizes a four-port fiber-optic circulator to passively double-pass a laser pulse through both a cFBG and a gain fiber so as to stretch and amplify the laser pulse, according to an embodiment.

FIG. 13 illustrates a system for stretching and amplifying a laser pulse by passively double-passing the laser pulse through both a cFBG and a gain fiber, wherein a three-port fiber-optic circulator serves as an input/output interface, according to an embodiment.

### DETAILED DESCRIPTION OF THE INVENTION

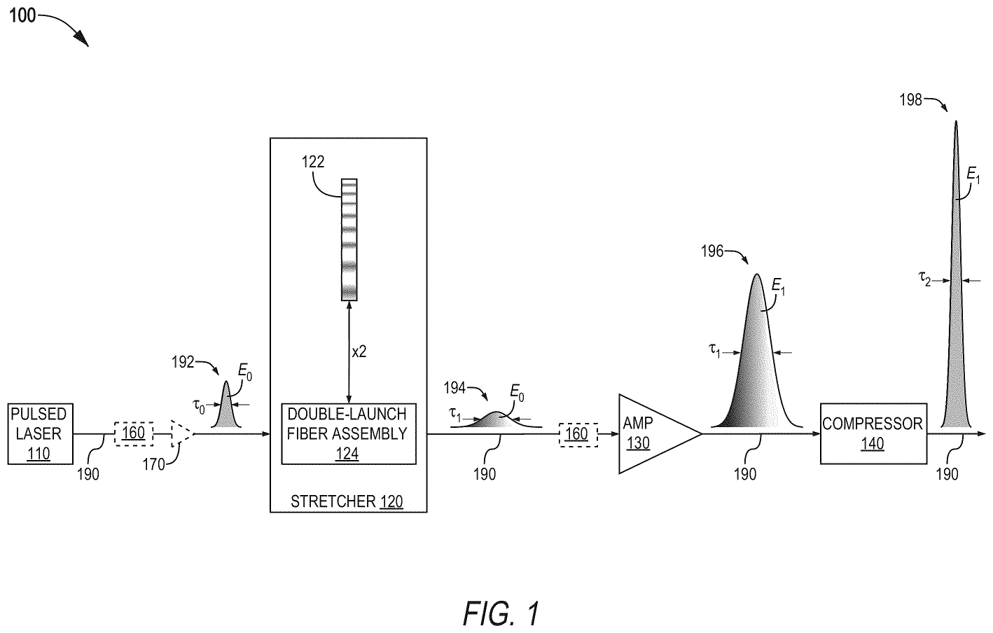

Referring now to the drawings, wherein like components are designated by like numerals, FIG. 1 illustrates one pulsed laser apparatus 100 with chirped pulse amplification utilizing a passively double-passed cFBG 122 to stretch the laser pulse before amplification. Apparatus 100 includes a pulsed laser 110, a stretcher 120, an amplifier 130, and a compressor 140. Laser 110 generates a laser beam 190 of ultrashort laser pulses 192. Each pulse 192 has a duration τ₀ and an energy E₀. Apparatus 100 applies chirped pulse amplification to laser beam 190 by sequential processing of laser beam 190 in stretcher 120, amplifier 130, and compressor 140.

Stretcher 120 chirps each pulse 192 to lengthen its duration so as to generate a respective stretched laser pulse 194 characterized by a longer pulse duration τ₁. For this purpose, stretcher 120 includes cFBG 122 and a double-launch fiber assembly 124. Assembly 124 is a passive assembly of fiber-optic components and optical fibers. Assembly 124 is configured to launch each pulse 192 into cFBG 122 twice before emitting the resulting, twice-stretched version of pulse 192 from stretcher 120 as stretched pulse 194. More specifically, for each pulse 192, assembly 124 first directs pulse 192 into cFBG 122 for a first reflection therein. This first reflection chirps the laser pulse to lengthen its duration. The first reflection returns the resulting, once-stretched laser pulse to assembly 124, whereafter assembly 124 directs the once-stretched laser pulse back into cFBG 122 for a second reflection therein. This second reflection further chirps and stretches the laser pulse, and returns the laser pulse to assembly 124 as the twice-stretched version of pulse 192, i.e., stretched pulse 194. The duration τ₁ of stretched pulse 194 is longer than the original pulse duration τ₀ of pulse 192. Furthermore, at least to a first-order approximation, the duration τ₁ of stretched pulse 194 may be about double the duration of the once-stretched pulse generated from the first reflection in cFBG 122. Stretcher 120 achieves this significantly enhanced stretching without incorporating a second cFBG and with no need for actively controlled components, thereby minimizing cost and operational complexity.

FIG. 1 depicts an ideal, lossless scenario, wherein the energy of stretched pulse 194 is the same as the energy of pulse 192, indicated in FIG. 1 as E₀. Practical implementations of stretcher 120 are likely to impose losses, such that the energy of stretched pulse 194 is less than E₀, for example between 5% and 70% of E₀. As compared to the peak power of pulse 192, the peak power of stretched pulse 194 is reduced by approximately a factor of τ₁/τ₀ in the lossless scenario, and more if losses are incurred.

Amplifier 130 amplifies each stretched pulse 194 to generate a respective amplified, stretched laser pulse 196. The duration of amplified, stretched pulse 196 is typically approximately τ₁ but its pulse energy is increased to a value E₁ that is significantly higher than E₀.

Compressor 140 unchirps each stretched, amplified pulse 196 to shorten its duration and thereby generate a respective amplified, ultrashort laser pulse 198. Compressor 140 shortens the pulse duration by imposing a chromatic dispersion with the opposite sign of the chromatic dispersion imposed by stretcher 120. In an ideal scenario, each amplified, ultrashort pulse 198 is characterized by the original pulse duration τ₀ of pulses 192. In many practical scenarios, however, the duration τ₂ of each amplified, ultrashort pulse 198 exceeds τ₀ by at least a small amount. Such a discrepancy is often caused by (a) temporal or spectral pulse distortion in one or both of stretcher 120 and amplifier 130 and/or (b) a mismatch between the respective chromatic dispersions imposed by compressor 140 and stretcher 120. In one embodiment, compressor 140 is nearly lossless, in which case the energy of amplified, ultrashort pulse 198 is close to E₁. In another embodiment, compressor 140 imposes a more substantial loss, and the energy of amplified, ultrashort pulse 198 may be between 60% and 90% of E₁.

Compressor 140 may be similar to stretcher 120 and include a passive double-launch fiber assembly that launches each amplified, stretched pulse 196 twice into a cFBG. This cFBG is configured to impose a chromatic dispersion of the opposite sign compared to the chromatic dispersion imposed by cFBG 122. Alternatively, compressor 140 may utilize a volume Bragg grating or one or more diffraction gratings to unchirp amplified, stretched pulse 196. Diffraction gratings may be better suited than cFBGs to handle the relatively high peak powers developing as the duration of amplified, stretched pulse 196 is being shortened.

The architecture of apparatus 100 may be applied in a range of scenarios, for example based on different types of lasers 110 and, accordingly, different characteristics of pulses 192. Laser 110 is, for example, a fiber laser or a diode-pumped solid-state laser. Pulse duration τ₀ may be less than 10 picoseconds (ps), for example in the range between 10 femtoseconds (fs) and 1 ps. The wavelength of pulses 192 may be in the range between 900 and 2200 nanometers (nm) or in the range between 1000 and 1100 nm. Laser 110 may generate pulses 192 with pulse energy E₀ in the range between 0.005 and 5 nanojoules (nJ) and at a repetition rate as high as 200 MHz, for example in the range between 5 MHz and 200 MHz.

Apparatus 100 may further include a pulse picker 160. Pulse picker 160 reduces the repetition rate of stretched pulses 194 as compared to the repetition rate of pulses 192 initially emitted by laser 110. By way of example, pulse picker 160 may be an acousto-optic modulator or an electro-optic modulator. A reduction in repetition rate may be necessary to achieve the desired pulse energies E₁ from amplifier 130. Pulse picker 160 may be positioned between stretcher 120 and amplifier 130, or between laser 110 and stretcher 120 to reduce the repetition rate of pulses 192 being coupled into stretcher 120. Both positions are indicated in FIG. 1. In either position, pulse picker 160 serves as a switch that allows only a subset of the laser pulses to propagate on to the next component (e.g., stretcher 120 or amplifier 130). Apparatus 100 may also include one or more preamplifiers 170. In the embodiment depicted in FIG. 1, preamplifier 170 amplifies pulses 192 prior to processing by stretcher 120. In this position, preamplifier 170 may amplify pulse energy E₀ to, e.g., between 0.1 and 100 nJ. The amplification by preamplifier 170 is kept at a level that prevents unacceptable distortion of pulses 192. In another embodiment, not depicted in FIG. 1, preamplifier 170 is positioned between stretcher 120 and amplifier 130. In embodiments of apparatus 100 that include both pulse picker 160 and one or more preamplifiers 170, preamplification may take place before and/or after pulse-picking.

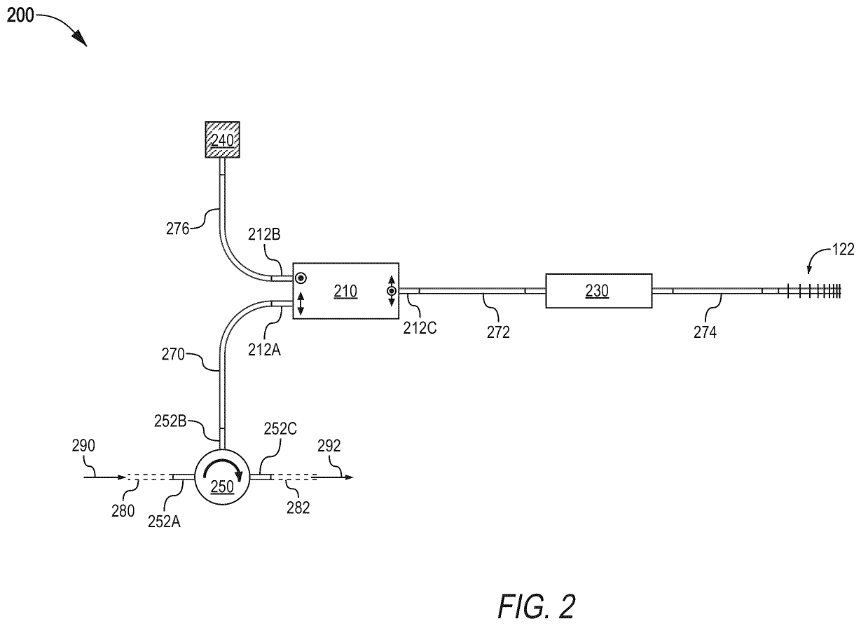

FIG. 2 illustrates one system 200 for stretching or compressing an input laser pulse 290 by passively double-passing input laser pulse 290 through cFBG 122. A three-port fiber-optic circulator 250 serves as an input/output interface of system 200. (Herein, a “three-port fiber-optic circulator” refers to a fiber-optic circulator with three or more ports.) Embodiments of system 200 configured to lengthen the pulse duration may be implemented in apparatus 100 as stretcher 120, in which case input pulse 290 is ultrashort pulse 192. Embodiments of system 200 configured to shorten the pulse duration may be implemented in apparatus 100 as compressor 140, in which case input pulse 290 is amplified, stretched pulse 196. System 200 includes cFBG 122, a fiber-optic polarization combiner 210, a fiber-optic Faraday rotator 230, a retroreflector 240, and circulator 250. Each of combiner 210, Faraday rotator 230, retroreflector 240, and circulator 250 may be a standard fiber-optic component, for example configured with fiber pigtails or coupling lenses. Alternatively, one or more of combiner 210, Faraday rotator 230, retroreflector 240, and circulator 250 may be replaced by an equivalent free-space optical component or assembly.

Faraday rotator 230 rotates the polarization of laser radiation, passing therethrough, by 45 degrees. Retroreflector 240 is configured to retroreflect light incident thereon from an optical fiber. Retroreflector 240 may be implemented directly on or in the optical fiber. For example, retroreflector 240 may be a reflective coating on the optical fiber or a reflective Bragg grating encoded in the optical fiber. Alternatively, retroreflector 240 is separate from the optical fiber. For example, retroreflector 240 may be a mirror mounted in fiber-optic package together with a coupling lens that couples laser radiation between the optical fiber and the mirror. Combiner 210 has three ports 212A, 212B, and 212C. Combiner 210 optically couples laser radiation of a first polarization between ports 212A and 212C. Laser radiation of a second polarization, orthogonal to the first polarization, is coupled between ports 212B and 212C. Port 212B is fiber-coupled to retroreflector 240, and port 212C is fiber-coupled to cFBG 122 via Faraday rotator 230. Circulator 250 has ports 252A, 252B, and 252C. Laser radiation coupled into circulator 250 at port 252A is emitted from port 252B, and laser radiation coupled into circulator 250 at port 252B is emitted from port 252C. Port 252B of circulator 250 is fiber-coupled to port 212A of combiner 210.

In operation, system 200 receives input pulse 290 at port 252A of circulator 250. Port 252A may be arranged to receive input pulse 290 from laser 110 or from amplifier 130. Circulator 250 directs input pulse 290 via port 252B to port 212A of combiner 210. It is assumed here that input pulse 290, when coupled into port 212A, is of the first polarization with respect to combiner 210. (In the event that input pulse 290 includes a component of the second polarization, this component will fail to propagate properly through system 200 and may be considered lost.) Combiner 210 then directs input pulse 290 from port 212C to cFBG 122 via Faraday rotator 230. Reflection of input pulse 290 in cFBG 122 alters the duration of input pulse 290 once and directs the once-altered laser pulse back to port 212C of combiner 210 via Faraday rotator 230. By virtue of the two passes through Faraday rotator 230 back and forth between combiner 210 and cFBG 122, the once-altered laser pulse is of the second polarization when returning to port 212C. Therefore, combiner 210 couples the once-altered laser pulse to port 212B and directs the once-altered laser pulse from port 212B to retroreflector 240. Retroreflector 240 reflects the once-altered laser pulse back to port 212B. The once-altered laser pulse is still of the second polarization when coupled into port 212B. Combiner 210 couples the once-altered laser pulse to port 212C, wherefrom combiner 210 directs the once-altered laser pulse from port 212C and via Faraday rotator 230 to cFBG 122 for a second reflection therein. This second reflection in cFBG 122 further alters the pulse duration, resulting in a twice-altered laser pulse 292. Twice-altered pulse 292 returns to port 212C of combiner 210. At this point, due to the two passes through Faraday rotator 230 to and from the second reflection in cFBG 122, twice-altered pulse 292 is of the first polarization. Combiner 210 therefore couples twice-altered pulse 292 via port 212A to port 252B of circulator 250, whereafter circulator 250 emits twice-altered pulse 292 from port 252C.

Optimal performance of combiner 210 to achieve two passes of the same laser pulse in cFBG 122 with minimal losses requires controlling the polarization state of the laser pulse. For the purpose of polarization control, the fiber-couplings between combiner 210, Faraday rotator 230, cFBG 122, retroreflector 240, and circulator 250 may be in the form of polarization-maintaining optical fibers. For example, as depicted in FIG. 2, system 200 may include polarization-maintaining optical fibers 270, 272, 274, and 276. Although usually less practical, one or more of the fiber couplings of system 200 may be replaced by free-space propagation sections.

Port 252A of circulator 250 may receive input pulse 290 from an optical fiber 280, and port 252C of circulator 250 may couple twice-altered pulse 292 into an optical fiber 282. Each of fibers 280 and 282 may be polarization-maintaining.

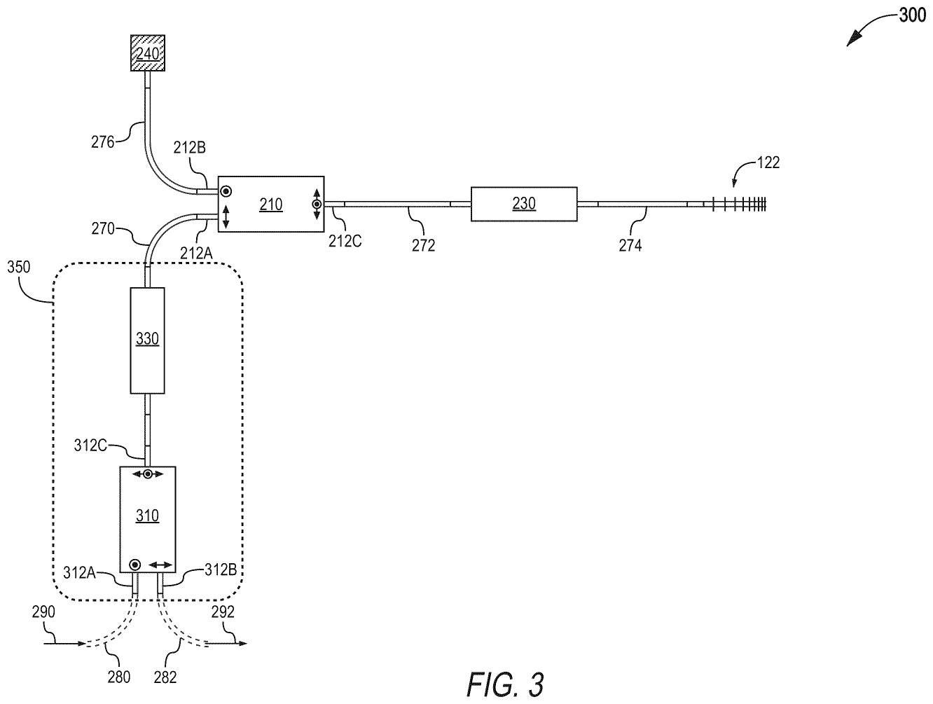

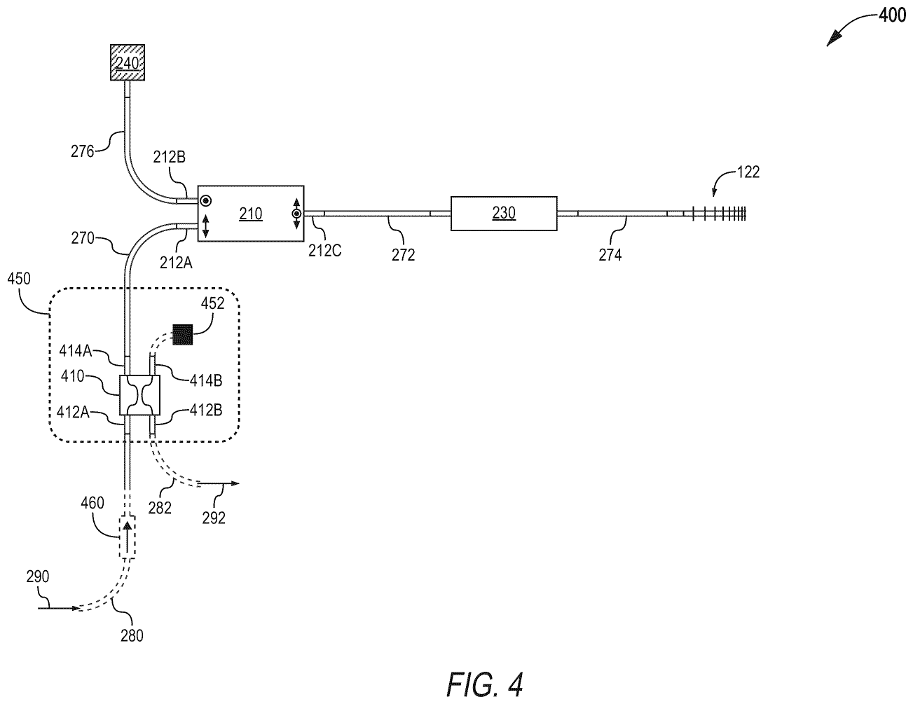

While circulator 250 may be a standard fiber-optic circulator, provided as a standard fiber-optic package, non-standard forms of circulators may be employed instead. Two examples are discussed below in reference to FIGS. 3 and 4.

FIG. 3 illustrates a system 300, which is an embodiment of system 200 wherein a polarization combiner 310 and a Faraday rotator 330 cooperate to form a non-standard three-port fiber-optic circulator 350. Combiner 310 is similar to combiner 210 and has ports 312A, 312B, and 312C, similar to ports 212A, 212B, and 212C, respectively. Port 312C is fiber-coupled to port 212A of combiner 210 via Faraday rotator 330. Faraday rotator 330 rotates the polarization of light, passing therethrough, by 45 degrees. Circulator 350 is a slightly more complex but equally cost-effective alternative to a standard three-port fiber-optic circulator.

In operation, system 300 receives input pulse 290 at port 312A of combiner 310. When coupled into port 312A, input pulse 290 is of the first polarization with respect to combiner 310. Combiner 310 therefore couples input pulse 290 to port 312C and directs input pulse 290 from port 312C to port 212A of combiner 210 via Faraday rotator 330. The coupling between combiners 310 and 210 is configured such that the 45-degree polarization-rotation in Faraday rotator 330 results in input pulse 290 being of the first polarization with respect to combiner 210 when input pulse 290 is coupled into port 212A. When combiner 210 emits twice-altered pulse 292 from port 212A, twice-altered pulse 292 undergoes an additional 45-degree polarization-rotation in Faraday rotator 330 before reaching port 312C. As a result, combiner 310 emits twice-altered pulse 292 from port 312B.

FIG. 4 illustrates a system 400, which is an embodiment of system 200 with a three-port fiber-optic circulator 450 based on a 2×2 fiber-optic coupler 410. Coupler 410 has input ports 412A and 412B, and output ports 414A and 414B. In one embodiment, coupler 410 is a 50:50 2×2 fiber-optic coupler (also known in the art as a 50:50 splitter). In this embodiment, laser radiation coupled into either one of the input ports is divided equally between the output ports, and laser radiation coupled into either one of the output ports is divided equally between the input ports. Coupler 410 may be a standard fiber-optic component, for example configured with a pigtail or coupling lens at each port.

Output port 414A is fiber-coupled to port 212A of combiner 210. In operation, input port 412A receives input pulse 290. Coupler 410 couples a fraction, e.g., 50%, of input pulse 290 to output port 414A. Coupler 410 directs this fraction of input pulse 290 from output port 414A to combiner 210 to have its duration altered twice by cFBG 122, resulting in twice-altered pulse 292. Combiner 210 directs twice-altered pulse 292 to output port 414A of coupler 410. Coupler 410 couples a fraction, e.g., 50%, of twice-altered pulse 292 to input port 412B. Input port 412B serves as the output port of system 400.

System 400 may include a beam dump 452, coupled to output port 414B, to absorb the fraction of input pulse 290 coupled to output port 414B rather than output port 414A. System 400 may also include an optical isolator 460, coupled to input port 412A. Optical isolator 460 prevents further backwards propagation of the fraction of twice-altered pulse 292 coupled to input port 412A rather than input port 412B.

As compared to system 300 and embodiments of system 200 utilizing a standard three-port fiber-optic circulator, system 400 is lossy because of the laser pulse fractions coupled to the “wrong” ports of coupler 410. Even under optimal circumstances, twice-altered pulse 292 contains at most 25% of the energy originally in input pulse 290 when coupled into input port 412A of coupler 410. However, in some scenarios, circulator 450 may be more easily implemented than circulator 350 or a standard three-port fiber-optic circulator.

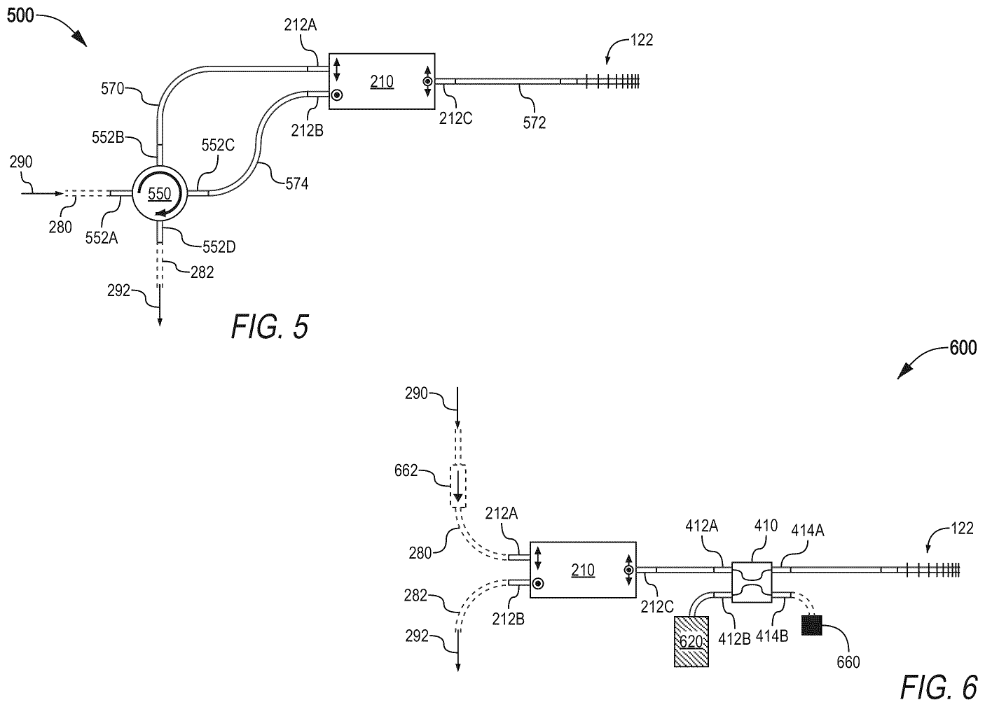

FIG. 5 illustrates another system 500 for stretching or compressing input laser pulse 290 by passively double-passing input laser pulse 290 through a cFBG. System 500 is an alternative to system 200 that utilizes a four-port fiber-optic circulator 550 to direct input pulse 290 to cFBG 122 twice. (Herein, a “four-port fiber-optic circulator” refers to a fiber-optic circulator with four or more ports.) System 500 includes cFBG 122, circulator 550, and combiner 210.

Circulator 550 has ports 552A, 552B, 552C, and 552D. Laser radiation coupled into port 552A is emitted from port 552B, laser radiation coupled into port 552B is emitted from port 552C, and laser radiation coupled into port 552C is emitted from port 552D. Circulator 550 may be a standard four-port fiber-optic circulator, for example configured with pigtails or coupling lenses. Ports 552B and 552C are fiber-coupled to ports 212A and 212B, respectively, of combiner 210. Port 212C of combiner 210 is fiber-coupled to cFBG 122.

In operation, system 500 receives input pulse 290 at port 552A of circulator 550, for example via fiber 280. Circulator 550 directs input pulse 290 from port 552B to port 212A of combiner 210. Input pulse 290 is of the first polarization, with respect to combiner 210, when coupled into port 212A. Therefore, polarization combiner 210 couples input pulse 290 from port 212A to port 212C and directs input pulse 290 to cFBG 122. A first reflection of input pulse 290 in cFBG 122 alters its duration to produce a once-altered laser pulse and returns the once-altered laser pulse to port 212C of combiner 210. At this point, the once-altered laser pulse is of the first polarization with respect to combiner 210. Combiner 210 therefore couples the once-altered laser pulse to port 212A and directs the once-altered laser pulse back to port 552B of circulator 550. After receiving the once-altered laser pulse at port 552B, circulator 550 directs the once-altered laser pulse from port 552C to port 212B of combiner 210.

The fiber couplings between combiner 210 and circulator 550 are configured to exert a 90-degree polarization rotation, with respect to combiner 210, of the once-altered laser pulse between (a) being emitted by port 212A of combiner 210 in the direction toward circulator 550 and (b) being coupled into port 212B of combiner 210. This polarization rotation may be achieved by suitable coupling of polarization-maintaining optical fibers, such as polarization-maintaining optical fibers 570, 572, and 574 depicted in FIG. 5. Fiber 574 may be connected to port 212B at an orientation that ensures that the once-altered laser pulse is of the second polarization, with respect to combiner 210, when coupled into port 212B.

When combiner 210 receives the once-altered laser pulse at port 212B, combiner 210 couples the once-altered laser pulse to port 212C and directs the once-altered laser pulse to a second reflection in cFBG 122, so as to generate twice-altered pulse 292. The second reflection in cFBG 122 returns twice-altered pulse 292 to port 212C of combiner 210, at which point twice-altered pulse 292 is of the second polarization with respect to combiner 210. Combiner 210 therefore couples twice-altered pulse 292 to port 212B and directs twice-altered pulse 292 from port 212B to port 552C of circulator 550. Circulator 550 emits twice-altered pulse 292 from port 552D, for example via fiber 282.

FIG. 6 illustrates another system 600 that utilizes a 2×2 fiber-optic coupler to double-pass input laser pulse 290 through a cFBG to be stretched or compressed. System 600 is another alternative to system 200. System 600 includes cFBG 122, 2×2 coupler 410, polarization combiner 210, and a fiber-optic Faraday mirror 620. Coupler 410 is fiber-coupled between combiner 210 and cFBG 122. Ports 212A and 212B of combiner 210 serve as input and output ports of system 600. Port 212C of combiner 210 is fiber-coupled to input port 412A of coupler 410. cFBG 122 is fiber-coupled to output port 414A of coupler 410. Faraday mirror 620 is fiber-coupled to input port 412B of coupler 410. For the purpose of polarization control, the fiber-couplings between combiner 210, coupler 410, cFBG 122, and Faraday mirror 620 may be in the form of polarization-maintaining optical fibers.

In operation, input pulse 290 is coupled into port 212A of combiner 210, for example via fiber 280. When coupled into port 212A, input pulse 290 is of the first polarization with respect to combiner 210 such that combiner 210 forwards input pulse 290 to input port 412A of coupler 410. Coupler 410 forwards a fraction, e.g., 50%, of input pulse 290 via output port 414A to cFBG 122. (The rest of input pulse 290 is emitted by output port 414B and, for example, absorbed by an optional beam dump 660 fiber-coupled thereto.) cFBG 122 reflects the fraction of input pulse 290 received from coupler 410 to produce a once-altered laser pulse. This first reflection in cFBG 122 returns the once-altered laser pulse to coupler 410. Coupler 410 forwards a fraction, e.g., 50%, of the once-altered laser pulse via input port 412B to Faraday mirror 620. (The rest of the once-altered laser pulse is forwarded to combiner 210 and emitted by port 212A thereof, and optionally blocked by an optical isolator 662.) Faraday mirror 620 reflects the fraction of the once-altered laser pulse received from coupler 410 and rotates the polarization of the once-altered laser pulse by a total of 90 degrees. Coupler 410 then forwards a fraction, e.g., 50%, of the polarization-rotated, once-altered laser pulse to a second reflection in cFBG 122. cFBG 122 returns the now twice-altered and polarization-rotated laser pulse to coupler 410. Coupler 410 forwards a fraction, e.g., 50%, of the twice-altered and polarization-rotated laser pulse to combiner 210. When coupled into port 212C of combiner 210, the twice-altered and polarization-rotated laser pulse is of the second polarization and is therefore coupled to port 212B of combiner 210. Combiner 210 emits the twice-altered and polarization-rotated laser pulse from port 212B as twice-altered pulse 292. Combiner 210 may couple twice-altered pulse 292 into fiber 282.

Due to the total of four passes through coupler 410, required to alter the duration of input pulse 290 twice in system 600, the energy of twice-altered pulse 292 contains at most 6.25% of the original energy of input pulse 290 when initially coupled into system 600. While this loss is substantial, system 600 is still a viable architecture for passively double-passing laser pulses through a cFBG.

Each of systems 200, 300, 400, 500, and 600 rely on polarization control to achieve two passes in cFBG 122. Without departing from the scope hereof, deviations from ideal polarization may exist. For example, the polarization-rotation angle imposed by either one of Faraday rotators 230 and 330 may deviate somewhat from 45 degrees, e.g., by up to 5 degrees. Similarly, the polarization-rotation angle imposed by Faraday mirror 620 may deviate somewhat from 90 degrees. Such deviations as well as other deviations in polarization control lead to loss. That is, an associated fraction of input pulse 290 fails to transfer to twice-altered pulse 292. In some scenarios, such losses may be acceptable. Thus, herein, reference to a polarization state or a polarization-rotation angle is understood to include a range of, e.g., ±5 degrees about the explicitly stated polarization state or angle.

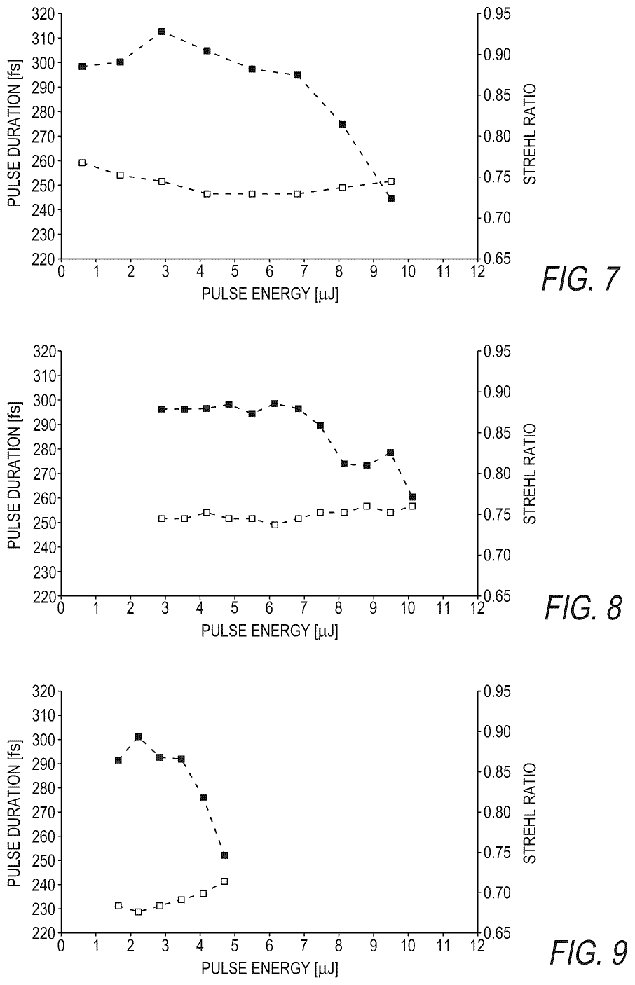

FIGS. 7, 8, and 9, are plots that demonstrate the measured performance of examples of systems 200 and 500, when implemented in apparatus 100 as stretcher 120. FIG. 7 plots the duration and temporal Strehl ratio of amplified, ultrashort pulse 198 generated when using system 200 to stretch ultrashort pulse 192. FIG. 8 plots the duration and temporal Strehl ratio of amplified, ultrashort pulse 198 generated when using system 500 to stretch ultrashort pulse 192. For comparison, FIG. 9 plots the duration and temporal Strehl ratio of an amplified, ultrafast pulse generated when only single-passing cFBG 122 in a modification of apparatus 100. FIGS. 7, 8, and 9 plot the pulse duration (open squares) and Strehl ratio (closed squares) as a function of the energy of ultrashort pulse 198. Different pulse energies were produced by adjusting the operation of amplifier 130. In these examples, compression was performed by a diffraction grating pair, and the compressor grating separation and angle were optimized for each data point in the plots.

The temporal Strehl ratio is a measure of the temporal quality of a laser pulse. For a transform limited laser pulse, the temporal Strehl ratio must be 1.0. A temporal Strehl ratio of less than unity indicates temporal distortion of the laser pulse. Some applications rely on the laser pulses having minimal temporal distortion, for example corresponding to a Strehl ratio of no less than 0.85.

Comparing first the plots of FIGS. 7 and 8, it is evident that similar pulse durations of amplified, ultrashort pulse 198 are achieved with systems 200 and 500. When using either one of systems 200 and 500, pulse energies of about 7 microJoules (μJ) can be obtained before the Strehl ratio drops below 0.85. In contrast, as evident from FIG. 9, when ultrashort pulse 192 is stretched only once in cFBG 122, the Strehl ratio drops below 0.85 already at a pulse energy of less than 4 μJ. This indicates that the additional stretching of ultrashort pulse 192 allows for stronger amplification in amplifier 130 before temporal/spectral distortion becomes substantial. On the other hand, the final pulse duration of amplified, ultrashort pulse 198 is shorter when making only a single pass in cFBG 122. This is evident from the pulse durations generally being between about 230 and 240 fs in the single-passed scenario (see FIG. 9), while the pulse durations are generally between about 250 and 260 fs in the double-passed scenarios (see FIGS. 7 and 8). The slightly longer pulse durations in FIGS. 7 and 8 indicate a mild degradation in pulse compressibility in the double-passed systems. However, for applications relying on high pulse energy and minimal temporal pulse distortion, the present examples of systems 200 and 500 outperform the single-passed alternative.

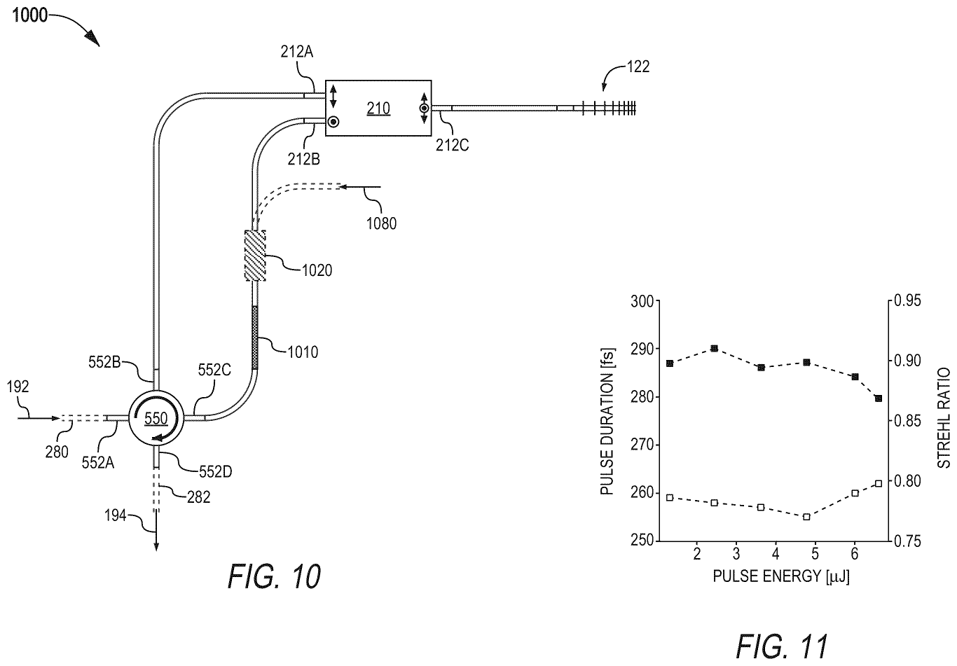

Referring again to FIG. 1, preamplifier 170 amplifies each pulse 192 prior to coupling into stretcher 120 in certain embodiments of apparatus 100. As a convenient alternative to such embodiments, a gain fiber may instead be included in double-launch fiber assembly 124 of stretcher 120. For example, consider embodiments of any one of pulse-duration-alteration systems 200, 300, 400, 500, and 600 configured for pulse stretching in cFBG 122. These embodiments may include a gain fiber in one of the existing fiber-couplings such that pulse 192 is subjected to amplification during its propagation through the system. Specific examples are discussed below in reference to FIGS. 10-13.

FIG. 10 illustrates one system 1000 for stretching and amplifying pulse 192 by passively double-passing pulse 192 through both cFBG 122 and a gain fiber 1010. System 1000 utilizes four-port fiber-optic circulator 550. System 1000 is an extension of system 500 that further includes gain fiber 1010, and wherein cFBG 122 is configured for stretching. Gain fiber 1010 is positioned in the fiber-coupling between circulator port 552C and combiner port 212B, and the laser pulse passes through gain fiber 1010 twice. With this positioning of gain fiber 1010, amplification is applied only after the laser pulse has undergone some degree of stretching, thereby reducing the risk or degree of pulse distortion during amplification. Specifically, the once-stretched laser pulse, returned to circulator port 552B after a first pass in cFBG 122, makes the first pass through gain fiber 1010 when propagating from circulator port 552C toward combiner port 212B. Next, after a second pass in cFBG 122, the twice-stretched laser pulse returning from cFBG 122 via combiner port 212B makes the second pass through gain fiber 1010 when propagating toward circulator port 552C. Circulator port 552D emits the resulting twice-stretched and amplified laser pulse (an example of pulse 194).

A fiber-optic embodiment of pulse picker 160 may be fiber-coupled to circulator 550 to simplify implementation in embodiments of apparatus 100 that require a repetition rate reduction or bursts of pulses. The fiber-optic embodiment of pulse picker 160 may be fiber-coupled to (a) circulator port 552D to reduce the repetition rate of the twice-stretched and amplified laser pulsed forwarded to amplifier 130, or (b) circulator port 552A to reduce the repetition rate of pulses 192 stretched and amplified by system 1000.

Gain fiber 1010 may be a rare-earth-ion doped fiber, such as an ytterbium-ion doped fiber. System 1000 may further include a fiber-optic wavelength multiplexer 1020 that couples pump laser radiation 1080 into gain fiber 1010 to energize gain fiber 1010. The location of multiplexer 1020 depicted in FIG. 10 is only one of several possible locations. For example, multiplexer 1020 may instead be positioned between circulator 550 and gain fiber 1010.

FIG. 11 is a plot demonstrating the measured performance of one example of system 1000 when implemented in apparatus 100 as stretcher 120 with integrated preamplification. FIG. 11 plots the duration and temporal Strehl ratio of amplified, ultrashort pulse 198 generated when using system 1000 to stretch and preamplify ultrashort pulse 192. FIG. 11 plots the pulse duration (open squares) and Strehl ratio (closed squares) as a function of the energy of ultrashort pulse 198. The pulse durations achieved using system 1000 are similar to those achieved with systems 200 and 500 (see FIGS. 7 and 8), and the Strehl ratio remains above 0.85 for pulse energies in excess of 6 μJ.

Gain fiber 1010 may generate some amount of amplified spontaneous emission (ASE). However, amplified, ultrashort pulses 198 generated in the FIG. 11 example were found to contain only minimal ASE.

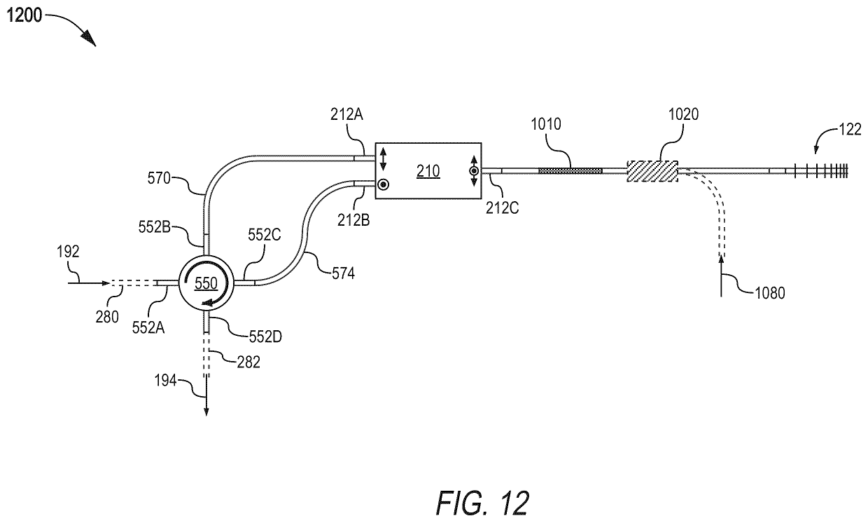

FIG. 12 illustrates another system 1200 that utilizes four-port fiber-optic circulator 550 to passively double-pass pulse 192 through both cFBG 122 and gain fiber 1010 so as to stretch and amplify pulse 192. System 1100 is a modification of system 1000, wherein gain fiber 1010 (and optional multiplexer 1020, if included) is instead positioned in the fiber-coupling between combiner 210 and cFBG 122. With gain fiber 1010 in this position, ASE generated in gain fiber 1010 may propagate in a loop (via combiner port 212A, circulator port 552B, circulator port 552C, and combiner port 212B) back to gain fiber 1010. This feedback loop may lead to undesirable seeding of continuous-wave ASE. However, it is possible to reduce ASE generation by maintaining a high repetition rate of pulses 192 coupled into system 1200. For this reason, if system 1200 is implemented in an embodiment of apparatus 100 that includes pulse picker 160, it may be preferable to position pulse picker 160 between system 1200 and amplifier 130, as opposed to before system 1200.

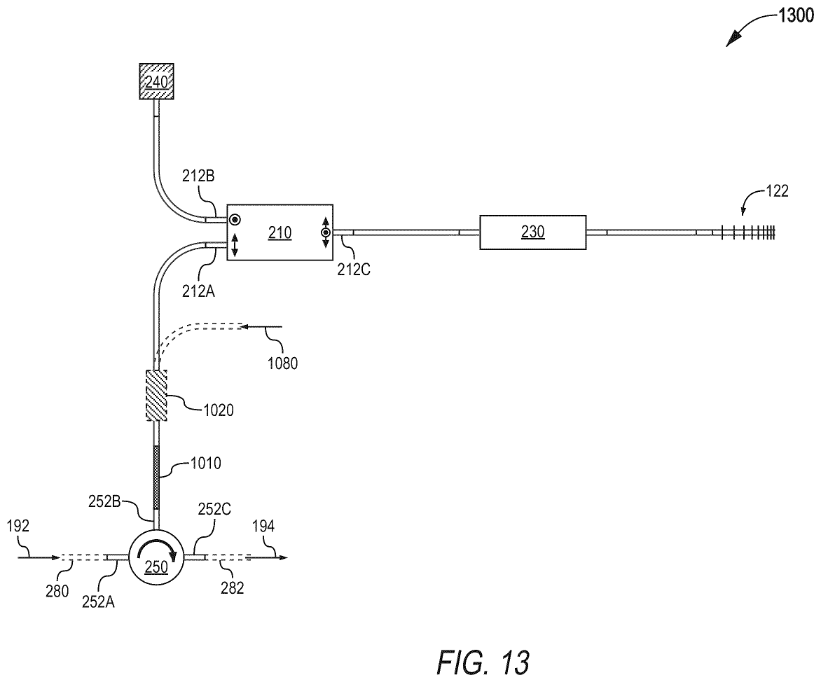

FIG. 13 illustrates one system 1300 for stretching and amplifying pulse 192 to passively double-pass pulse 192 through both cFBG 122 and gain fiber 1010, wherein three-port fiber-optic circulator 250 serves as an input/output interface. System 1300 is an extension of system 200 that further includes gain fiber 1010 in the fiber-coupling between circulator 250 and combiner 210. System 1300 may also include multiplexer 1020 to couple pump laser radiation 1080 into gain fiber 1010. FIG. 13 depicts one exemplary position of multiplexer 1020.

In a manner similar to that discussed above for coupling of pulse picker 160 to circulator 550 in system 1000, a fiber-optic embodiment of pulse picker 160 may be fiber-coupled to circulator port 252A or 252C in system 1300.

System 1300 may be modified to position gain fiber 1010 (and optional multiplexer 1020, if included) in the fiber-coupling between combiner 210 and cFBG 122, or in the fiber-coupling between combiner 210 and retroreflector 240. Positioning of gain fiber 1010 between combiner 210 and retroreflector 240 mitigates issues associated with amplification before stretching. However, when gain fiber 1010 is positioned between cFBG 122 and retroreflector 240, these two reflectors may form a resonator for continuous-wave lasing. The risk of continuous-wave lasing may be reduced by maintaining a high repetition rate of pulses 192 coupled into system 1300. In a related embodiment of apparatus 100, a high repetition rate of pulses 192 coupled into system 1300 may be achieved by placing pulse picker 160 between system 1300 and amplifier 130 or by omitting pulse picker 160 entirely.

The present invention is described above in terms of a preferred embodiment and other embodiments. The invention is not limited, however, to the embodiments described and depicted herein. Rather, the invention is limited only by the claims appended hereto.

What is claimed is:

1. A system for altering duration of a laser pulse, comprising:
a chirped fiber Bragg grating for stretching or compressing the laser pulse;
a Faraday rotator configured to rotate polarization of laser radiation by 45 degrees per pass therethrough;
a retroreflector; and
a first fiber-optic polarization combiner having first, second, and third combiner ports, and configured to optically couple (a) laser radiation of a first polarization between the first and third combiner ports and (b) laser radiation of a second polarization between the second and third combiner ports, the first and second polarizations being mutually orthogonal, the third combiner port being fiber-coupled to the chirped fiber Bragg grating via the Faraday rotator and the second combiner port being fiber-coupled to the retroreflector, whereby:
when the laser pulse is coupled into the first combiner port with the first polarization, the first fiber polarization combiner (1) directs the laser pulse to a first reflection in the chirped fiber Bragg grating, then (2) directs the laser pulse to the retroreflector, then (3) directs the laser pulse to a second reflection in the chirped fiber Bragg grating, and then (4) emits the laser pulse from the first combiner port.

2. The system of claim 1, further comprising a fiber-optic circulator having first, second, and third circulator ports and configured to (a) emit, from the second circulator port, laser radiation coupled into the first circulator port, and (b) emit, from the third circulator port, laser radiation coupled into the second circulator port, wherein the second circulator port is fiber-coupled to the first combiner port.

3. A system for stretching and amplifying a laser pulse, comprising:
the system of claim 2, wherein the fiber-coupling between the second circulator port and the first combiner port includes a gain fiber for amplifying the laser pulse.

4. The system of claim 1, further comprising:
a second Faraday rotator configured to rotate polarization of laser radiation by 45 degrees per pass therethrough; and
a second fiber-optic polarization combiner having first, second, and third ports, and configured to optically couple (a) laser radiation of a third polarization between the first and third ports and (b) laser radiation of a fourth polarization between the second and third ports, the third and fourth polarizations being mutually orthogonal, the third port of the second fiber-optic polarization combiner being fiber-coupled to the first combiner port via the second Faraday rotator, whereby:
when the laser pulse is coupled into the first port of the second fiber-optic polarization combiner, the laser pulse is emitted by the second port of the second fiber-optic polarization combiner after the first and second reflections in the chirped fiber Bragg grating.

5. The system of claim 1, wherein the first fiber-optic polarization combiner is coupled to each of the Faraday rotator and the retroreflector by a respective polarization-maintaining optical fiber, and wherein the Faraday rotator is coupled to the chirped fiber Bragg grating by a polarization-maintaining optical fiber.

6. The system of claim 1, wherein the chirped fiber Bragg grating is configured to stretch the laser pulse.

7. A pulsed laser apparatus, comprising:
a laser source for generating pulsed laser radiation;
the system of claim 6 arranged to stretch laser pulses of the pulsed laser radiation to generate stretched laser pulses; and
an amplifier for amplifying the stretched laser pulses to generate amplified, stretched laser pulses.

8. The pulsed laser apparatus of claim 7, further comprising a pulse picker fiber-coupled to the first or third circulator port.

9. The pulsed laser apparatus of claim 7, further comprising a compressor for compressing the amplified, stretched laser pulses.

10. The pulsed laser apparatus of claim 7, wherein the laser source is a fiber laser that is fiber-coupled to the system.

11. A system for altering duration of a laser pulse, comprising:
a chirped fiber Bragg grating for stretching or compressing the laser pulse;
a fiber-optic polarization combiner having first, second, and third combiner ports, the fiber-optic polarization combiner being configured to optically couple (a) laser radiation of a first polarization between the first and third combiner ports and (b) laser radiation of a second polarization between the second and third combiner ports, the first and second polarizations being mutually orthogonal, the third combiner port being fiber-coupled to the chirped fiber Bragg grating; and
a fiber-optic circulator having first, second, third, and fourth circulator ports and configured to (a) emit, from the second circulator port, laser radiation coupled into the first circulator port, (b) emit, from the third circulator port, laser radiation coupled into the second circulator port, and (c) emit, from the fourth circulator port, laser radiation coupled into the third circulator port;
wherein the second circulator port is fiber-coupled to the first combiner port to direct a laser pulse coupled into the first combiner port to a first reflection in the chirped fiber Bragg grating, and the third circulator port is fiber-coupled to the second combiner port to subsequently direct the laser pulse to a second reflection in the chirped fiber Bragg grating.

12. The system of claim 11, wherein the second circulator port is coupled to the first combiner port by a first polarization-maintaining optical fiber, the third circulator port is coupled to the second combiner port by a second polarization-maintaining optical fiber, and the third combiner port is coupled to the chirped fiber Bragg grating by a third polarization-maintaining optical fiber.

13. The system of claim 12, wherein the second polarization-maintaining optical fiber is arranged to exert a 90-degree polarization-rotation, with respect to the fiber polarization combiner.

14. The system of claim 11, wherein the chirped fiber Bragg grating is configured to stretch the laser pulse.

15. A system for stretching and amplifying a laser pulse, comprising:
the system of claim 11, wherein the fiber-coupling between the third circulator port and the second combiner port includes a gain fiber for amplifying the laser pulse.

16. The system of claim 15, further comprising a pulse picker fiber-coupled to the first or fourth circulator port.

17. A pulsed laser apparatus, comprising:
a laser source for generating pulsed laser radiation;
the system of claim 15 arranged to stretch and amplify laser pulses of the pulsed laser radiation to generate preamplified, stretched laser pulses; and
an amplifier for amplifying the preamplified, stretched laser pulses to generate amplified, stretched laser pulses.

18. The pulsed laser apparatus of claim 17, further comprising a compressor for compressing the amplified, stretched laser pulses.

19. The pulsed laser apparatus of claim 17, further comprising a pulse picker.

20. A system for stretching and amplifying a laser pulse, comprising:
the system of claim 11, wherein the fiber-coupling between the third combiner port and the chirped fiber Bragg grating includes a gain fiber for amplifying the laser pulse.
